(19) United States
(12) Patent Application Publication
(10) Pub. No.: US 2023/0152094 A1
(43) Pub. Date: May 18, 2023

(54) SURVEY SYSTEM, SURVEY METHOD, AND SURVEY PROGRAM

(71) Applicant: NILEWORKS INC., Tokyo (JP)

(72) Inventors: Yutaka MURAKUMO, Tokyo (JP); Chihiro WAKE, Tokyo (JP); Hiroki KATO, Tokyo (JP)

(21) Appl. No.: 17/919,800

(22) PCT Filed: Apr. 20, 2020
(86) PCT No.: PCT/JP2020/016999

§ 371 Date: Oct. 19, 2022

(51) Int. Cl. G01C 15/02; B64C 39/02; B64U 10/00

(52) U.S. Cl. CPC G01C 15/02; B64C 39/024; B64U 10/00; B64U 2101/32

(57) ABSTRACT

A survey system for accurately surveying an area includes a coordinate acquisition section that acquires a set of three-dimensional coordinates of a survey point or a base station used for determining sets of coordinates of the area, as a set of measurement coordinates, a comparative coordinate acquisition section that acquires at least a height-direction coordinate value of a set of comparative coordinates indicating a position within a predetermined range from the acquired set of measurement coordinates; and a determining section that calculates a difference between a height-direction coordinate value of the set of measurement coordinates and the height-direction coordinate value of the set of comparative coordinates and determines that at least any one of the set of measurement coordinates and the set of comparative coordinates are incorrect when the difference is larger than a predetermined value.

### TECHNICAL FIELD

The invention of the present application relates to a survey system, a survey method, and a survey program.

### BACKGROUND ART

The application of a small helicopter (multicopter) generally called a drone has progressed. One of important fields of the application is spreading chemical agent, such as agrochemical and liquid fertilizer, over farmland (an agricultural field) (e.g., see Patent Literature 1). For relatively narrow farmland, using a drone rather than a piloted airplane or helicopter is often suitable.

Thanks to a technology such as a quasi-zenith satellite system and a real time kinematic-global positioning system (RTK-GPS), it is possible to grasp an absolute position of a drone in flight accurately down to several centimeters, thereby enabling autonomous flight with a minimum of manual control and efficient, accurate spreading of chemical agent even in farmland having a narrow, complicated terrain, which is typically seen in Japan.

Patent Literature 2 discloses an apparatus that estimates a position and an attitude of a mobile body, and the apparatus performs, for each of receivers, a determination process in which an estimated reception position of one of the receivers is used as a reference position, and whether an estimated reception position of each of the other receivers is appropriate is determined. Patent Literature 3 discloses a positioning system that determines the positions of mobile radio stations assuming that mobile wireless terminals and base radio stations are on substantially the same horizontal plane. When a difference in height between antennas and the inclination of an antenna base line of the antennas are not negligible, the positions of the mobile wireless terminals are determined by making a three-dimensional correction of their orientations and positions based on known heights of antennas of the base radio stations and a known topographic feature of an area.

Patent Literature 4 discloses a GPS device with monitoring means in which a plurality of GPS receivers each having an antenna are installed in a mobile body. A monitoring device included in the GPS device with monitor means compares some or all of pieces of relative positioning information outputted by the receivers and determines whether the pieces of positioning information are within a range of a mutual relation that is assumed from an installation position relation among the antennas. Patent Literature 5 discloses a localization device that determines whether multipath occurs by calculating radio path lengths between a satellite and a first GPS antenna and a second GPS antenna that are disposed a predetermined distance away from each other and receive a signal from the same satellite.

### CITATION LIST

### Patent Literature

### Patent Literature 1

Japanese Domestic Re-publication of PCT International Application No. 2017/175804

### Patent Literature 2

Japanese Patent Laid-Open No. 2020-008420

### Patent Literature 3

Japanese Patent Laid-Open No. 2008-139292

### Patent Literature 4

Japanese Patent Laid-Open No. 11-137956

### Patent Literature 5

Japanese Patent Laid-Open No. 7-43780

### SUMMARY OF INVENTION

### Technical Problem

An objective of the present invention is to survey an agricultural field accurately.

### Solution to Problem

A survey system according to an aspect of the present invention to achieve the objective described above is a survey system for surveying an area, the survey system including: a coordinate acquisition section that acquires a set of three-dimensional coordinates of a survey point or a base station used for determining sets of coordinates of the area, as a set of measurement coordinates; a comparative coordinate acquisition section that acquires at least a height-direction coordinate value of a set of comparative coordinates indicating a position within a predetermined range from the acquired set of measurement coordinates; and a determining section that calculates a difference between a height-direction coordinate value of the set of measurement coordinates and the height-direction coordinate value of the set of comparative coordinates and determines that at least any one of the set of measurement coordinates and the set of comparative coordinates are incorrect when the difference is larger than a predetermined value.

The comparative coordinate acquisition section may extract plane coordinates of the set of measurement coordinates, specify the set of comparative coordinates of which the plane coordinates are within the predetermined range, and acquire at least the height-direction coordinate value of the set of comparative coordinates.

The comparative coordinate acquisition section may take, as the set of comparative coordinates, a set of coordinates of a second survey point that differs from the survey point in an acquisition time of a set of coordinates of the base station that is referred to for positioning the survey point.

The comparative coordinate acquisition section may take, as the set of comparative coordinates, coordinate information provided from a GPS-based control station or an external system.

The comparative coordinate acquisition section may take, as the height-direction coordinate value of the set of comparative coordinates, an average value in a height direction of coordinate values of a plurality of neighborhood survey points or GPS-based control stations that are present within the predetermined range from the measurement coordinates.

The comparative coordinate acquisition section may acquire a plurality of sets of comparative coordinates that are present within the predetermined range from the set of measurement coordinates and present at positions surrounding the set of measurement coordinates, and the determining section may calculate differences between height-direction coordinates of the plurality of sets of comparative coordinates and the height-direction coordinate value of the set of measurement coordinates, perform the determination based on the differences, and determine that at least any one of the set of measurement coordinates and the sets of comparative coordinates is incorrect when any one of the differences is greater than a predetermined value.

When the survey system receives a command to register the area based on a plurality of the survey points that have been measured and used for determining sets of coordinates of the area, the determining section may perform the determination on each of the plurality of survey points, and when determining, for a set of measurement coordinates of at least one of the survey points, that any one of a set of the comparative coordinates and the set of measurement coordinates is incorrect, the determining section may inhibit registration of the area or issue, via an interface device, a notification of promoting resurvey of the survey point.

When the survey system receives a command to register a flight route for the area based on a plurality of the survey points, the determining section may perform the determination on each of the plurality of survey points, and when determining, for a set of measurement coordinates of at least one of the survey points, that any one of a set of the comparative coordinates and the set of measurement coordinates is incorrect, the determining section may inhibit registration of the flight route.

When determining that the set of measurement coordinates of the base station is incorrect, the determining section may inhibit measurement of the survey point.

A survey method according to another aspect of the present invention to achieve the objective described above is a survey method for surveying an area, the survey method including: a coordinate acquisition step of acquiring a set of three-dimensional coordinates of a survey point or a base station used for determining sets of coordinates of the area, as a set of measurement coordinates; a comparative coordinate acquisition step of acquiring at least a height-direction coordinate value of a set of comparative coordinates indicating a position within a predetermined range from the acquired set of measurement coordinates; and a determining section that calculates a difference between a height-direction coordinate value of the set of measurement coordinates and the height-direction coordinate value of the set of comparative coordinates and determines that at least any one of the set of measurement coordinates and the set of comparative coordinates are incorrect when the difference is larger than a predetermined value.

A survey program according to still another aspect of the present invention to achieve the objective described above is a survey program for surveying an area, the survey program causing a computer to execute: a coordinate acquisition command to acquire a set of three-dimensional coordinates of a survey point or a base station used for determining sets of coordinates of the area, as a set of measurement coordinates; a comparative coordinate acquisition command to acquire at least a height-direction coordinate value of a set of comparative coordinates indicating a position within a predetermined range from the acquired set of measurement coordinates; and a determining command to calculate a difference between a height-direction coordinate value of the set of measurement coordinates and the height-direction coordinate value of the set of comparative coordinates and determine that at least any one of the set of measurement coordinates and the set of comparative coordinates are incorrect when the difference is larger than a predetermined value.

Note that the computer program can be provided by download over a network such as the Internet or may be provided being recorded in one of various types of computer-readable recording media such as a CD-ROM.

### Advantageous Effect of Invention

It is possible to perform the survey of an agricultural field accurately.

### BRIEF DESCRIPTION OF DRAWINGS

FIG. 1 is a plan view of a drone included in a survey system according to the invention of the present application.

FIG. 2 is a front view of the drone.

FIG. 3 is a right side view of the drone.

FIG. 4 is a rear view of the drone.

FIG. 5 is a perspective view of the drone.

FIG. 6 is a general schematic diagram of a flight control system for the drone.

FIG. 7 is a block diagram of functions that the drone has.

FIG. 8 is a functional block diagram of the survey system.

FIG. 9 is a schematic diagram illustrating an example in which measurement coordinates are incorrect, where (a) is a schematic diagram illustrating a state where base station coordinates on a ground surface are incorrectly measured in a vertical direction, and (b) is a schematic diagram illustrating a state where a survey point on a ground surface is incorrectly measured in the vertical direction.

FIG. 10 is a picture depicting one example of an area definition screen displayed on an operating device included in the survey system.

FIG. 11 is a picture depicting how an agricultural field defined on the area definition screen is displayed.

FIG. 12 is a flowchart illustrating a flow of determining the appropriateness of base station coordinates.

FIG. 13 is a flowchart of determining the appropriateness of sets of survey point coordinates in response to the reception of an instruction to register an area.

FIG. 14 is a flowchart of determining the appropriateness of sets of survey point coordinates in response to the reception of an instruction to generate a flight route to an agricultural field.

### DESCRIPTION OF EMBODIMENTS

An embodiment for carrying out the invention of the present application will be described below with reference to the drawings. The drawings are all for exemplification purposes. In a detailed description to be given below, specific details will be described for explanation and for helping complete understanding of a disclosed embodiment. However, embodiments are not limited to these specific details. In addition, well-known structures and devices are illustrated schematically for simplification of the drawings.

First, a configuration of a drone according to the present invention will be described. In the present specification, a drone refers to an aerial vehicle in general including a plurality of rotary wings, irrespective of its type of motive power (electric motor, heat engine, etc.) and its type of control (wireless or wired, autonomous flight or manual control, etc.)

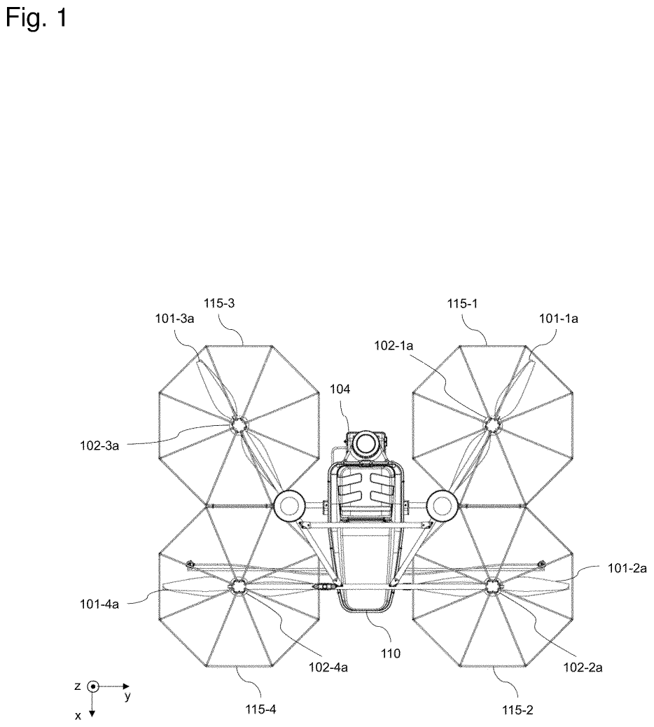

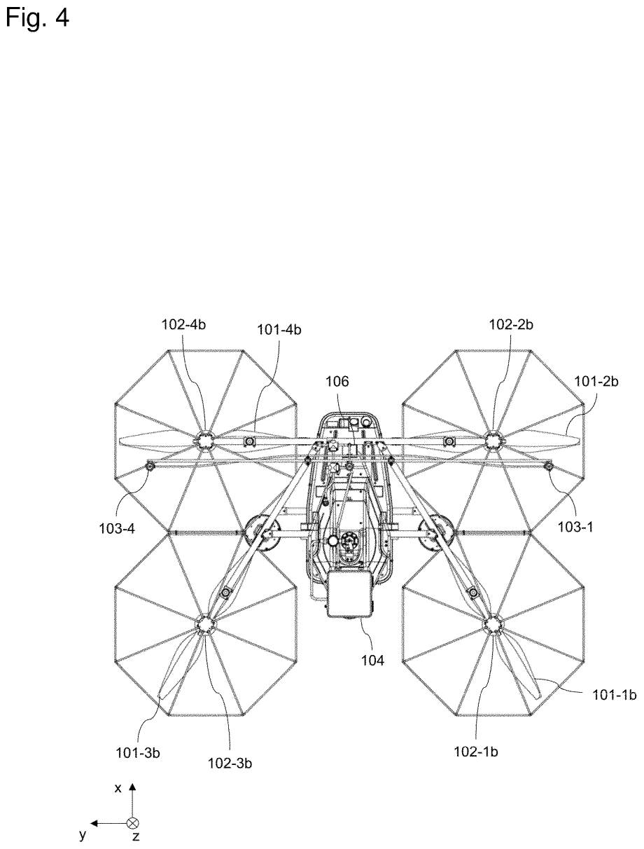

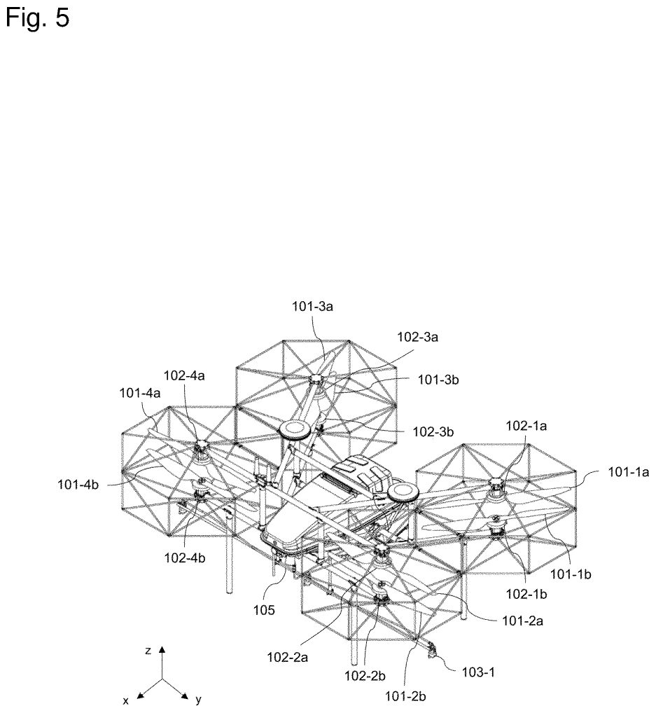

As illustrated in FIG. 1 to FIG. 5, rotary wings 101-1a, 101-1b, 101-2a, 101-2b, 101-3a, 101-3b, 101-4a, and 101-4b (also referred to as rotors) are means for causing a drone 100 to fly, and eight rotary wings (four sets of double-tier rotary wings) are provided, with consideration given to the balance among flight stability, a size of an airframe, and power consumption. The rotary wings 101 are disposed, with arms extending from a casing 110, at positions in four directions from the casing 110 of the drone 100. That is, as viewed in a traveling direction of the drone 100, the rotary wings 101-1a and 101-1b are disposed behind the casing 110 on the left, the rotary wings 101-2a and 101-2b are disposed ahead of the casing 110 on the left, the rotary wings 101-3a and 101-3b are disposed behind the casing 110 on the right, and the rotary wings 101-4a and 101-4b are disposed ahead of the casing 110 on the right. Note that a traveling direction of the drone 100 is a downward direction in the paper of FIG. 1.

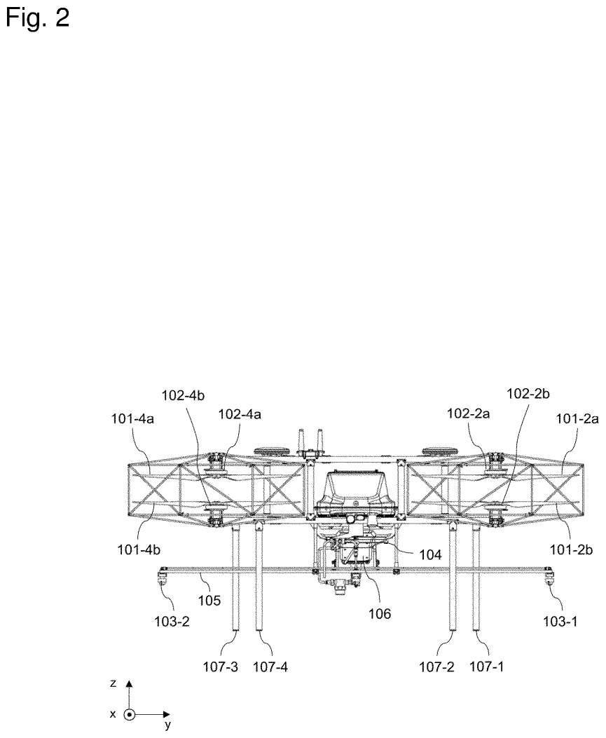

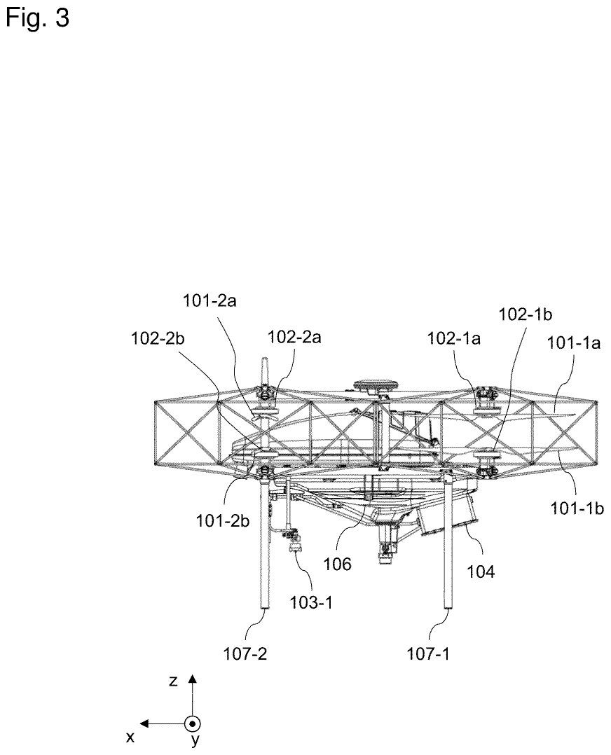

On the periphery of the sets of the rotary wings 101, latticed propeller guards 115-1, 115-2, 115-3, and 115-4 each forming a substantially cylindrical shape are provided for making it difficult for a foreign object to interfere with a rotary wing 101. As illustrated in FIG. 2 and FIG. 3, spoke-like members for supporting the propeller guards 115-1, 115-2, 115-3, and 115-4 each have a turreted structure rather than a flat structure. This is because, in case of a collision, the structure urges the member to buckle outward of the rotary wing, preventing the member from interfering with the rotor.

Below the rotary wings 101, rod-shaped legs 107-1, 107-2, 107-3, and 107-4 extend along the rotation axes of the rotary wings 101.

Motors 102-1a, 102-1b, 102-2a, 102-2b, 102-3a, 102-3b, 102-4a, and 102-4b are means for causing the rotary wings 101-1a, 101-1b, 101-2a, 101-2b, 101-3a, 101-3b, 101-4a, and 101-4b to rotate (typically electric motors but may be engines, etc.), respectively, and are each provided for one rotary wing. The motors 102 exemplify thrusters. Up and down rotary wings of one of the sets (e.g., 101-1a and 101-1b) and their respective motors (e.g., 102-1a and 102-1b) include axes lying on the same line and rotate in directions opposite to each other for the flight stability of the drone and the like.

Nozzles 103-1 and 103-2 are means for spreading a substance to be spread downward, and four nozzles are provided. Note that, in the present specification, the substance to be spread generally refers to liquid or powder to be spread over an agricultural field, such as agrochemical, herbicide, liquid fertilizer, insecticide, seeds, and water.

A tank 104 is a tank for storing the substance to be spread and is provided at a position close to and below the center of gravity of the drone 100, from the viewpoint of weight balance. A hose 105 is means for connecting the tank 104 and the nozzles (103-1 and 103-2), made of a hard material, and may additionally play a role of supporting the nozzles. A pump 106 is means for discharging the substance to be spread from the nozzles.

Flight Control System

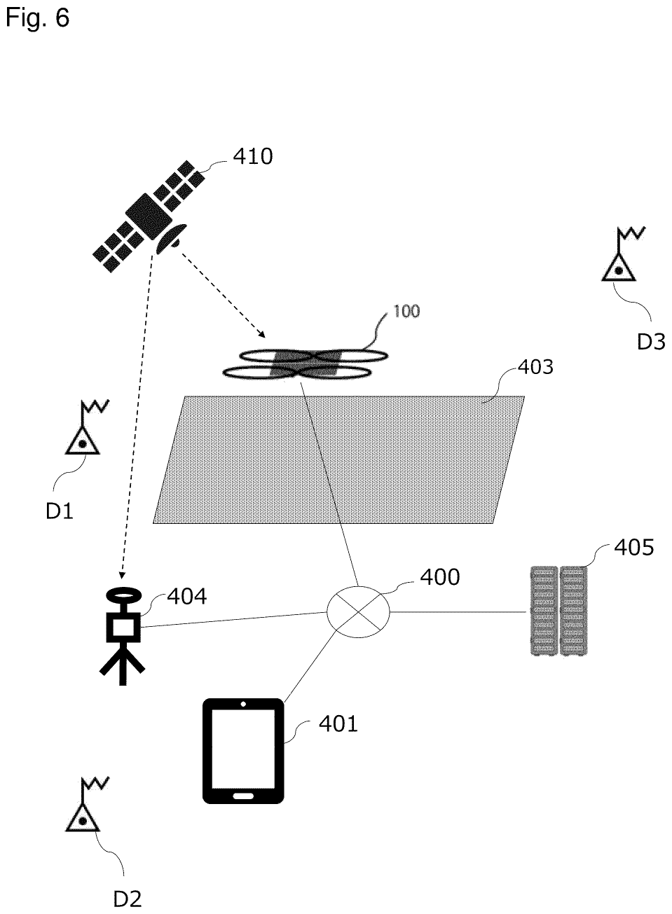

FIG. 6 illustrates a general schematic diagram of a flight control system for the drone 100 according to the invention of the present application. This diagram is schematic, and its scale is not exact. In this figure, the drone 100, an operating device 401, a base station 404, and a server 405 are connected together via a mobile communication network 400. These connections may be implemented by Wi-Fi wireless communication in place of the mobile communication network 400, or some or all of the connections may be wired. Further, the flight control system may have a configuration in which constituent components are connected directly in place of or in addition to using the mobile communication network 400.

Drone

The drone 100 and the base station 404 communicate with a positioning satellite 410 in a GNSS such as the GPS, acquiring coordinates of the drone 100 and the base station 404. There may be a plurality of positioning satellites 410 with which the drone 100 and the base station 404 communicate.

Operating Device

The operating device 401 is means for transmitting an instruction to the drone 100 in response to an operation made by a user and for displaying information received from the drone 100 (e.g., position, a stored amount of the substance to be spread, remaining battery level, image taken by a camera, etc.) and may be implemented in a form of common mobile information equipment such as a tablet computer on which a computer program runs. The operating device 401 includes an input section and a display section as user interface devices. The drone 100 according to the invention of the present application is controlled so as to perform autonomous flight but may be configured to allow manual operation in basic operations such as a takeoff and a return and in an emergency situation. In addition to the mobile information equipment, an emergency operating device (not illustrated) having a dedicated function of making an emergency stop may be used. The emergency operating device may be a dedicated device provided with a large emergency stop button or the like for dealing speedily with an emergency situation. Further, in addition to the operating device 401, a small portable terminal capable of displaying some or all of the pieces of information to be displayed on the operating device 401, such as a smartphone, may be included in the system. For example, the small portable terminal is connected to the base station 404, thus being capable of receiving information and the like from the server 405 via the base station 404.

Agricultural Field

An agricultural field 403 is a rice field, field, or the like over which spreading is performed by the drone 100. In reality, topographic features of the agricultural field 403 are complex, and there is a case where no topographic map is available in advance or a case where a given topographic map disagrees with site conditions of the agricultural field 403. The agricultural field 403 is usually adjacent to a house, hospital, school, agricultural field of another crop, road, railroad, or the like. In the agricultural field 403, an obstacle such as a building, an electric wire, or the like may be present. The agricultural field 403 is an example of an area.

Base Station

The base station 404 functions as an RTK-GNSS base station, thus being capable of providing an accurate position of the drone 100. Further, the base station 404 may be an apparatus that provides a host unit function in Wi-Fi communication, and the like. The host unit function in the Wi-Fi communication and the RTK-GNSS base station may be implemented as independent devices. Further, the base station 404 may be capable of communicating mutually with the server 405 using a mobile telecommunications system such as 3G, 4G, and LTE. The base station 404 and the server 405 constitute an agriculture cloud.

In addition, the base station 404 is capable of acquiring accurate coordinates by differential positioning based on a reference station. The reference station herein refers to what is called a GPS-based control station. Reference stations are installed at intervals of about 20 km, for example. Note that the reference stations include, for example, GPS-based control stations, which are installed and managed by a public institution such as the Geospatial Information Authority of Japan and provide information about absolute position coordinates, and private reference stations that are installed and managed by a private sector enterprise. Further, the reference station may be a virtual reference station generated based on a technology that produces, from observation data on a plurality of GPS-based control stations, a state as if a reference station is present in close proximity to a survey site. The GPS-based control stations are GNSS continuously operating reference stations (CORSs) and are installed at intervals of about 20 km. The relative positional relationship among the plurality of GPS-based control stations is obtained by differential positioning to an accuracy of one millionth. This accuracy means that the relative positional relationship between two adjacent GPS-based control stations is obtained with a margin of error of 2 cm. Likewise, the relative positional relationship between the base station 404 and the GPS-based control station is obtained to an accuracy of one millionth.

The differential positioning is a method for determining a relative positional relationship by observing four or more GNSS satellites of the same type simultaneously at two locations and by measuring a difference in time taken by radio signals from each GNSS satellite to reach the two locations. RTK-GNSS positioning performed with the base station 404 enables a position of the drone 100 to be provided with a margin of error of several centimeters, for example.

In FIG. 6, the coordinates of the base station 404 are calculated based on coordinates of at least one of reference stations D1, D2, and D3 that are placed in the vicinity of the base station 404.

The base station 404 is, for example, an apparatus placed in the vicinity of the agricultural field by a worker and is equipped with a battery that allows the base station 404 to function. After installation, the base station 404 acquires its coordinates when its power is turned on, or an appropriate operation is performed on the base station 404 in addition to the turning on of the power.

Server

The server 405 typically includes computers and relevant software operated on a cloud computing service and may be wirelessly connected to the operating device 401 through a mobile telephone line or the like. The server 405 may be constituted by a hardware device. The server 405 may analyze images of the agricultural field 403 captured by the drone 100, grasp the growth conditions of a crop, and perform processing for determining a flight route. Further, the server 405 may provide topographic information and the like on the agricultural field 403 stored therein to the drone 100. Moreover, the server 405 may accumulate records of flights of the drone 100 and images captured by the drone 100 and perform various types of analyses thereon.

The small portable terminal is, for example, a smartphone. The small portable terminal includes a display section that displays, as appropriate, information on an action predicted in relation to the operation of the drone 100, specifically, a scheduled time at which the drone 100 returns to a takeoff-landing point 406, information on details of work to be performed by a user after the drone 100 returns, and the like. Based on an input performed on the small portable terminal, an action of the drone 100 may be changed.

In general, the drone 100 takes off from a takeoff-landing point located outside the agricultural field 403, spreads the substance to be spread over the agricultural field 403, and returns to the takeoff-landing point after the spreading or when replenishment with the substance to be spread, electric recharging, or the like is needed. A flight route (entrance route) from the takeoff-landing point to the agricultural field 403 as a destination may be stored in advance in the server 405 or the like or may be inputted by a user before a takeoff. The takeoff-landing point may be a virtual location defined based on coordinates stored in the drone 100, or there may be a physical takeoff-landing platform.

Flight Controller

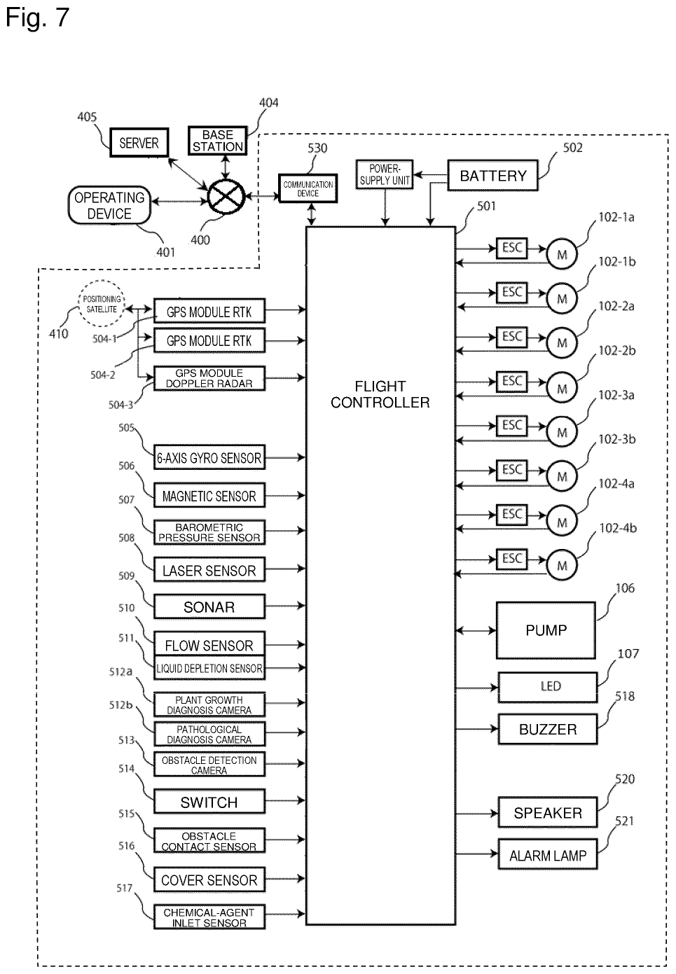

FIG. 7 is a block diagram illustrating control functions in an embodiment of a drone for performing spreading according to the invention of the present application. A flight controller 501 is a constituent component that governs the control of the entire drone and may be specifically an embedded computer including a CPU, a memory, relevant software, and the like. The flight controller 501 controls a flight of a drone 100 by controlling the numbers of revolutions of the motors 102-1a, 102-1b, 102-2a, 102-2b, 102-3a, 102-3b, 102-4a, and 102-4b via control means such as an electronic speed control (ESC) based on input information received from the operating device 401 and input information obtained from various types of sensors described later. The flight controller 501 is configured to receive feedback on actual numbers of revolutions of the motors 102-1a, 102-1b, 102-2a, 102-2b, 102-3a, 102-3b, 102-4a, and 102-4b so as to monitor whether their rotations are normal. Alternatively, the flight controller 501 may be configured to receive feedback on the rotations of the rotary wings 101 from optical sensors or the like provided at the rotary wings 101.

Software used for the flight controller 501 can be rewritten for enhancement/modification of a function, fixing a problem, or the like via a storage medium or the like or communication means such as Wi-Fi communication and USB. In this case, the software is protected by means of encryption, checksum, digital signature, virus-check software, and the like so as not to be rewritten by fraudulent software. In addition, calculation processing used by the flight controller 501 for the control may be partly executed by another computer that is present on the operating device 401 or the server 405 or at another location. Some or all of the constituent components of the flight controller 501 may be duplexed owing to its great importance.

The flight controller 501 is capable of receiving a necessary instruction from the operating device 401 and transmitting necessary information to the operating device 401 by exchanging data with the operating device 401 via a communication device 530 and, in addition, the mobile communication network 400. In this case, the communication may be encrypted to prevent fraudulent activities such as interception, spoofing, and hacking a device. The base station 404 has a communication function via the mobile communication network 400 as well as a function of an RTK-GPS base station. By combining a signal from the RTK base station 404 and signals from the positioning satellites 410 such as GPS satellites, an absolute position of the drone 100 can be measured with an accuracy of about several centimeters by the flight controller 501. The flight controller 501 may be duplexed/multiplexed owing to their great importance; in addition, redundant flight controllers 501 may be controlled to use another satellite so as to prepare for the failure of some GPS satellite.

A 6-axis gyro sensor 505 is means for measuring accelerations of the drone airframe in three directions orthogonal to one another and, in addition, is means for calculating velocities by integrating the accelerations. The 6-axis gyro sensor 505 is means for measuring changes in attitude angles, namely, angular velocities, of the drone airframe in the three directions described above. A geomagnetic sensor 506 is means for measuring a direction of the drone airframe by measuring the Earth's magnetic field. A barometric pressure sensor 507 is means for measuring barometric pressure and is also capable of measuring the altitude of the drone indirectly. A laser sensor 508 is means for measuring a distance between the drone airframe and a ground surface by using reflection of laser light, and infrared (IR) laser may be used for the laser sensor 508. A sonar 509 is means for measuring a distance between the drone airframe and the ground surface by using the reflection of a sound wave such as an ultrasonic wave. These sensors and the like may be selected in accordance with a cost target and performance requirements of the drone. In addition, a gyro sensor (angular velocity sensor) for measuring the inclination of the airframe, an anemometer sensor for measuring the force of wind, and the like may be added. These sensors and the like may be duplexed or multiplexed. In a case where there are a plurality of sensors provided for the same purpose, the flight controller 501 may use only one of the sensors, and if a failure occurs in the one, another one of the sensors may be switched to and used as an alternative sensor. Alternatively, the plurality of sensors may be used simultaneously, and if measurement results from the sensors disagree, the flight controller 501 may deem that a failure has occurred.

Flow sensors 510 are means for measuring flow rates of the substance to be spread and are provided at a plurality of locations on channels from the tank 104 to the nozzles 103. A liquid depletion sensor 511 is a sensor for detecting whether an amount of the substance to be spread has fallen to or below a predetermined amount.

A plant growth diagnosis camera 512a is means for capturing an image of the agricultural field 403 to acquire data for plant growth diagnosis. The plant growth diagnosis camera 512a is, for example, a multispectral camera and receives a plurality of light beams of different wavelengths. The plurality of light beams include, for example, red light (a wavelength of about 650 nm) and near-infrared light (a wavelength of about 774 nm). The plant growth diagnosis camera 512a may be a camera that receives visible light.

A pathological diagnosis camera 512b is means for capturing an image of crop growing in the agricultural field 403 to acquire data for pathological diagnosis. The pathological diagnosis camera 512b is, for example, red light camera. The red light camera is a camera that detects an amount of light in a frequency band corresponding to an absorption spectrum of chlorophyll, which is contained in plants. The red light camera detects, for example, an amount of light in a band centered about a wavelength of 650 nm. The pathological diagnosis camera 512b may detect an amount of light in frequency bands of red light and near-infrared light. Further, as the pathological diagnosis camera 512b, a red light camera and a visible light camera that detects amounts of light of at least three wavelengths in a visible light frequency band, such as an RGB camera, may be both provided. Note that the pathological diagnosis camera 512b may be a multispectral camera and may be configured to detect an amount of light in a band centered about a wavelength 650 nm to 680 nm.

Note that the plant growth diagnosis camera 512a and the pathological diagnosis camera 512b may be implemented as a single-piece hardware configuration.

An obstacle detection camera 513 is a camera for detecting an intruder for the drone and is a device different from the plant growth diagnosis camera 512a and the pathological diagnosis camera 512b because its image properties and the orientation of its lens are different from those of the plant growth diagnosis camera 512a and the pathological diagnosis camera 512b. A switch 514 is means with which the user 402 of the drone 100 makes various settings. An obstacle contact sensor 515 is a sensor for detecting that the drone 100, particularly its rotor portion or its propeller guard portion has come into contact with an intruder such as an electric wire, a building, a human body, a tree, a bird, and another drone. Note that the 6-axis gyro sensor 505 may substitute for the obstacle contact sensor 515. A cover sensor 516 is a sensor for detecting that a cover of an operation panel of the drone 100 or a cover for an internal maintenance is in an open state. An inlet sensor 517 is a sensor for detecting that an inlet of the tank 104 is in an open state.

These sensors and the like may be selected in accordance with a cost target and performance requirements of the drone and may be duplexed or multiplexed. In addition, a sensor may be provided in the base station 404, the operating device 401, or another location outside of the drone 100, and information read by the sensor may be transmitted to the drone. For example, an anemometer sensor may be provided in the base station 404, and information concerning the force and the direction of wind may be transmitted to the drone 100 via the mobile communication network 400 or the Wi-Fi communication.

The flight controller 501 transmits a control signal to the pump 106 to adjust an amount of discharge or stop the discharge. The flight controller 501 is configured to receive feedback on current conditions (e.g., the number of revolutions, etc.) of the pump 106.

An LED 107 is display means for informing an operator of the drone of a state of the drone. In place of or in addition to the LED, display means such as a liquid crystal display may be used. A buzzer is output means for indicating the state (particularly, an error state) of the drone using an aural signal. The communication device 530 is connected to the mobile communication network 400, which is 3G, 4G, LTE, or the like, and is connected to the agriculture cloud constituted by the base station and the server and to the operating device via the mobile communication network 400. In place of or in addition to the communication device, other types of wireless communication means such as Wi-Fi, infrared communication, Bluetooth®, ZigBee®, and NFC, or wired communication means such as USB connection may be used. A speaker 520 is output means for indicating the state (particularly, an error state) of the drone using recorded human voice, synthesized voice, or the like. In some weather conditions, a visual display by the drone 100 during flight is difficult to see; in this case, using voice to transmit the state is effective. An alarm lamp 521 is display means such as a strobe light for indicating the state (particularly, an error state) of the drone. These input/output means may be selected in accordance with a cost target and performance requirements of the drone and may be duplexed or multiplexed.

Survey System 500

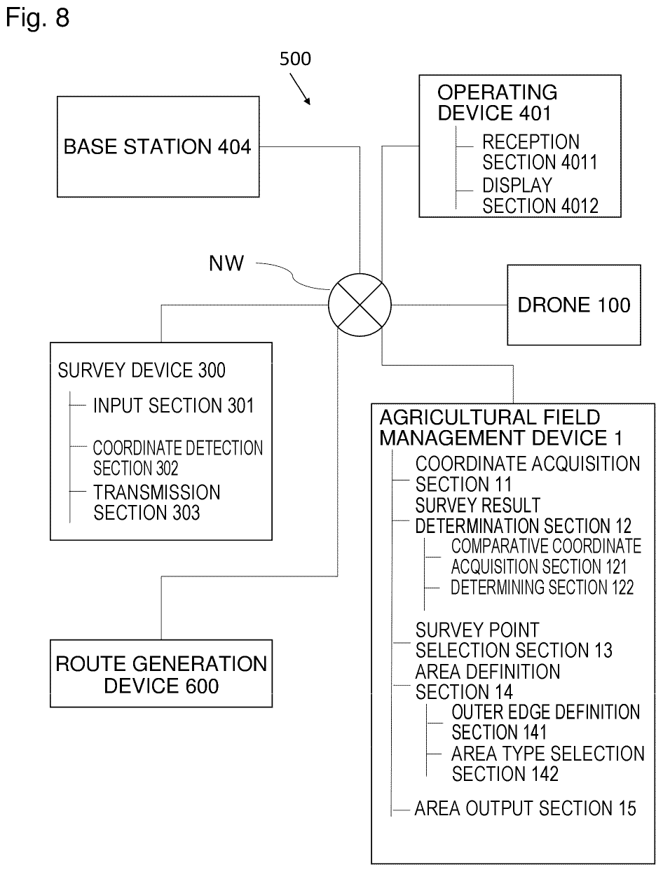

A survey system 500 illustrated in FIG. 8 is a system that defines an area of an agricultural field in which the drone 100 is to be caused to perform work, based on the coordinates of the base station 404 and sets of coordinates acquired by a survey device 300. Further, the survey system 500 determines whether the coordinates of the base station 404 and the sets of coordinates acquired by the survey device 300 have been measured correctly, and if the measurement is incorrect, the survey system 500 inhibits the registration of results of the measurement.

The survey system 500 includes, for example, an agricultural field management device 1, the drone 100, the operating device 401, the base station 404, the survey device 300, and a route generation device 600. The route generation device 600 generates a flight route in which the drone 100 is to fly autonomously in each of areas defined. Further, the agricultural field management device 1 defines an obstacle area that the drone 100 cannot enter. The flight route is generated in such a manner as to go around the obstacle area.

Functions of the agricultural field management device 1 may be installed on the server 405 or may be installed in a separate device. Alternatively, a configuration in which the drone 100 includes the agricultural field management device 1 may be adopted. Functions of the route generation device 600 may be installed on the server 405 as a route generation section, may be installed in a separate device, or may be included in the drone 100, the operating device 401, or the agricultural field management device 1. The agricultural field is an example of a work area.

Survey Device

The survey device 300 is a device having a function of an RTK-GNSS mobile station and is capable of surveying an agricultural field to obtain coordinate information on the ground surface of the agricultural field. The survey device 300 is a small device that a user can carry about, such as a rod-shaped device. The survey device 300 may be a stick-shaped device that is long enough to allow a user in an upright posture to hold a top-end portion of the device with a bottom end of the device being in contact with the ground. The number of survey devices 300 available to read coordinate information on an agricultural field may be one or more. With a configuration in which one agricultural field can be surveyed to obtain coordinate information thereon with a plurality of survey devices 300, a plurality of users can carry about the respective survey devices 300 in the agricultural field, which enables survey operation to be completed in a short time.

In addition, the survey device 300 is capable of measuring obstacles in or near an agricultural field to obtain information thereon. The obstacles include a wall, a slope, a utility pole, an electric wire, and the like that involves a risk of collision with the drone 100, and various types of objects that need not be spread with a chemical agent or monitored.

The survey device 300 includes an input section 301, a coordinate detection section 302, and a transmission section 303.

The input section 301 is provided at a top-end portion of the survey device 300, and for example, is a button that receives a press by a user. The user presses the button of the input section 301 when intending to measure coordinates of a bottom end of the survey device 300. Further, the input section 301 may have a configuration to receive an input for deleting data on a survey point of which coordinates have been measured once by a press.

The input section 301 is configured to receive information while distinguishing whether the received information is about coordinates of an outer edge of an agricultural field or coordinates of an outer edge of an obstacle. For example, the input section 301 may include at least two buttons, one of which is a button for acquiring coordinates of an outer edge of an agricultural field and the other of which is a button for acquiring coordinates of an outer edge of an obstacle. In addition, the input section 301 can receive coordinates of an outer edge of an obstacle in conjunction with a type of the obstacle.

The coordinate detection section 302 is a functional section capable of detecting three-dimensional coordinates of the bottom end of the survey device 300 by communicating with the base station 404 when necessary.

The transmission section 303 is a functional section that transmits, in response to an input to the input section 301, three-dimensional coordinates of the bottom end of the survey device 300 at a time of the input, via a network NW to the operating device 401 or the agricultural field management device 1. The transmission section 303 transmits the three-dimensional coordinates in order of pointing.

In a process of reading coordinate information on an agricultural field, a user moves in the agricultural field with the survey device 300 and performs pointing with the input section 301 at endpoints or edges of the agricultural field and obstacles.

Sets of three-dimensional coordinates of the endpoints or edges of the agricultural field that are acquired by the pointing and transmitted are received by the agricultural field management device 1 while being subjected to distinction between three-dimensional coordinates of an outer circumference of the agricultural field and sets of three-dimensional coordinates of the obstacles. Further, the three-dimensional coordinates acquired by the pointing may be received by a reception section 4011 of the operating device 401 and displayed by a display section 4012 of the operating device 401. Further, the operating device 401 may determine whether the received three-dimensional coordinates are appropriate as three-dimensional coordinates of the outer circumference of the agricultural field or the obstacles, and in a case where the determination is that remeasurement is needed, the operating device 401 may cause the display section 4012 to prompt the user to perform the resurvey.

Route Generation Device

The route generation device 600 is a functional section that generates a flight route of the drone 100 for causing the drone 100 to fly thoroughly in a work area such as an agricultural field to perform chemical agent spreading, image capturing, or the like. The route generation device 600 generates a flight route in a work area based on information on the work area and obstacles obtained from results of measurement by the survey device 300. For example, the flight route may be a route that scans the work area from side to side, a route that goes in a spiral manner from a substantial center of the work area toward the outside of the work area, or a route that goes in a spiral manner from the outside of the work area toward the substantial center of the work area. Alternatively, the flight route may be a route on which the drone 100 flies in the spiral manner and from side to side.

The route generation device 600 determines driving modes of the rotary wings based on the acquired sets of coordinates of the ground surface of the work area so that a flight altitude from the ground surface of the agricultural field stands at its target value. When the rotary wings are driven at the same number of revolutions the drone 100 moves horizontally, but in the case of an inclined ground surface, the altitude from the ground surface changes with the movement. The route generation device 600 makes the flight altitude from the ground surface constant by causing the drone 100 to ascend or descend based on vertical coordinates of the ground surface. This configuration enables densities of chemical agent spread from the drone 100 to be made as intended and enables image capturing of the agricultural field to be performed with a desired accuracy.

Agricultural Field Management Device

The agricultural field management device 1 includes an arithmetic unit for executing information processing, such as a central processing unit (CPU) and a storage device such as a random access memory (RAM) and a read only memory (ROM), with which the agricultural field management device 1 includes at least a coordinate acquisition section 11, a survey result determination section 12, a survey point selection section 13, an area definition section 14, and an area output section 15 as software resources.

The coordinate acquisition section 11 is a functional section that acquires, three-dimensional coordinates of the survey point or the base station used for determining sets of coordinates of the flight target area, as measurement coordinates. The coordinate acquisition section 11 acquires position coordinates of the base station 404 measured by the base station 404 and sets of coordinates of survey points measured with the survey device 300. The coordinate acquisition section 11 acquires the coordinates of the base station 404 and the sets of coordinates of the survey points while distinguishing them.

The coordinate acquisition section 11 may acquire the sets of coordinates of the survey points with their orders in which they are acquired with the survey device 300. The coordinate acquisition section 11 may acquire the sets of coordinates of the survey points with their times at which they are acquired with the survey device 300. Further, the coordinate acquisition section 11 may acquire, in association with information on a set of coordinates, a type that indicates whether the survey point is a point indicating coordinates of an outer edge of the agricultural field or a point indicating coordinates of an outer edge of the obstacle, that is, an area type to which the survey point belongs.

The survey result determination section 12 is a functional section that determines the appropriateness of the measurement coordinates of the base station 404 and the sets of measurement coordinates of the survey points acquired by the coordinate acquisition section 11.

In a case where the calculation of position coordinates is performed using a satellite signal, a phenomenon in which incorrect coordinates are outputted as a solution of the calculation, what is called false fixation, occurs on rare occasions. The false fixation is a phenomenon caused by the occurrence of a multipath or a delay of a radio wave due to solar flare and normally causes a solution not to converge, resulting in an error, but may result in an output of an incorrect solution on rare occasions. At this time, the error in the solution in a height direction is, for example, on the order of several meters. Although a deviation of a measurement result in a planar direction can be found by a user when a map and measurement coordinates are displayed in a superimposing manner, a deviation in a vertical direction is difficult to find by the displaying of a map. The survey result determination section 12 therefore makes a determination in a case where an error from an actual value is an error in the vertical direction. Note that the survey result determination section 12 is capable of detecting an error in the vertical direction even in a case where the error is not caused by the false fixation.

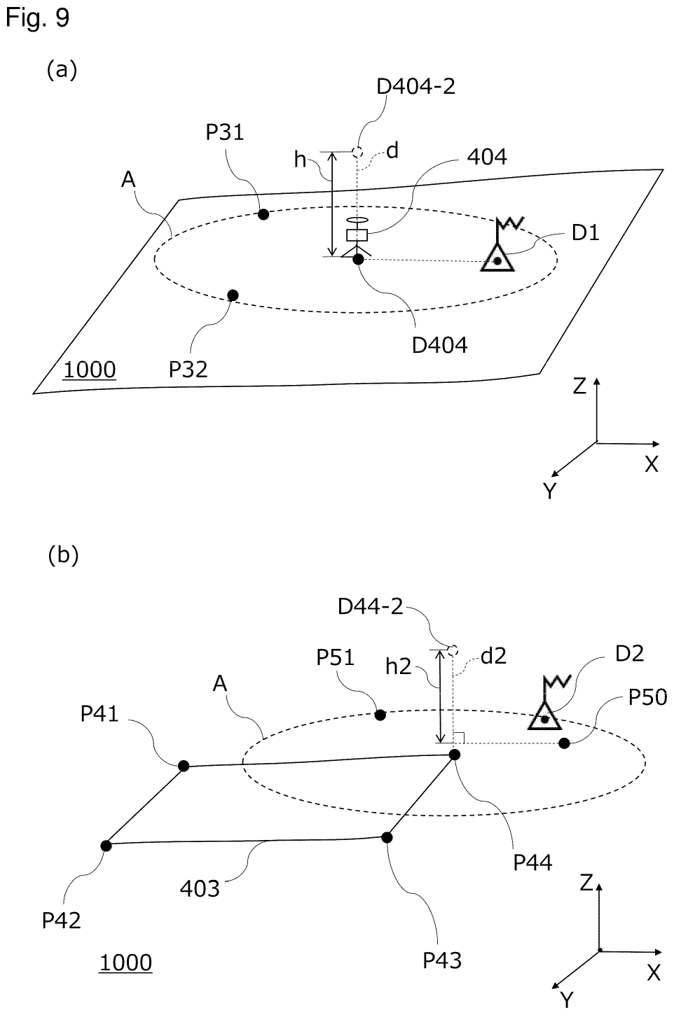

Further description of the survey result determination section 12 will be given using an example illustrated in FIG. 9(a). FIG. 9(a) illustrates a state where a measurement coordinate of the base station 404 in the vertical direction is incorrect. As illustrated in this figure, the base station 404 is an apparatus placed on a ground surface 1000, and therefore a height-direction coordinate value of base station coordinates D404 is of the ground surface 1000. However, in the example in this figure, a height-direction coordinate of measured coordinates D404-2 obtained by the coordinate acquisition section 11 is measured as being larger than the height-direction coordinate of the base station coordinates D404 by d because of false fixation. Further, there are neighborhood survey points P31 and P32 and a GPS-based control station D1 in the vicinity of the base station 404 and within a predetermined range A.

The predetermined range A is a range on an imaginary plane that is defined on the same plane of the acquired measured coordinates D404-2 of the base station and, for example, is a range within a circle of a predetermined radius from the measured coordinates D404-2 including its perimeter. The predetermined range A extends, for example, by 10 m to 20 m. The ground surface 1000 that includes the agricultural field 403 and a location where the base station 404 is placed can be assumed to be substantially flat. As a result, the possibility that a difference of height of several meters is made at a position 10 m to 20 m away from the base station 404 is low. Therefore, on the assumption that vertical coordinates, that is, altitudes are values close to one another within the predetermined range A, in a case where a difference in height direction between comparative coordinates and the measurement coordinates within the predetermined range A is several meters, any one of the comparative coordinates and the measurement coordinates can be determined as an incorrect value due to false fixation.

The survey result determination section 12 includes a comparative coordinate acquisition section 121 and a determining section 122.

The comparative coordinate acquisition section 121 is a functional section that acquires coordinate values to be compared with measurement coordinates. The comparative coordinate acquisition section 121 acquires at least a height-direction coordinate value of comparative coordinates indicating a position of acquired measurement coordinates within the predetermined range A. How to determine the comparative coordinates will be described later.

The determining section 122 is a functional section that compares the measurement coordinates with the comparative coordinates to determine the appropriateness of the measurement coordinates. The determining section 122 calculates a difference between a height-direction coordinate value of the measurement coordinates and a height-direction coordinate value of the comparative coordinates and determines that the measurement coordinates are correct when the difference is smaller than a predetermined value. When the difference is not less than the predetermined value, the determining section 122 determines that at least any one of the measurement coordinates and the comparative coordinates is incorrect.

Here, a detailed configuration of the comparative coordinate acquisition section 121, particularly how to determine the comparative coordinates to be acquired will be described. The comparative coordinate acquisition section 121 extracts plane coordinates of the measurement coordinates and determines, as the comparative coordinates, coordinates of a known location of which plane coordinates are within the predetermined range A.

Examples of the location having the known coordinates include the neighborhood survey points P31 and P32. The neighborhood survey points P31 and P32 differ from the survey point in the acquisition time of coordinates of the base station that are, for example, referred to for the positioning. For example, the comparative coordinate acquisition section 121 may store sets of measurement coordinates of the neighborhood survey points P31 and P32 and the acquisition time of the base station coordinates in association with each other and may compare the acquired time of the base station coordinates with acquired coordinates of the base station coordinates that are referred to for the sets of measurement coordinates, thus specifying a neighborhood survey point for which the base station coordinates differ in acquisition time.

For example, when the base station 404 is placed at another location, the base station 404 acquires its coordinates. The placement of the base station 404 at the other location can be performed at the start of work on another day, and thus base station coordinates acquired on the day may be referred to. This is because there is a low probability that coordinates of a survey point that are measured based on base station coordinates acquired at a different time point are subject to the same false fixation as that of the measured coordinates. With this configuration, false fixation of measurement coordinates can be detected. Note that the neighborhood survey points P31 and P32 may be points measured with another base station.

The comparative coordinate acquisition section 121 may be configured to acquire, as the comparative coordinates, coordinates of a position within the predetermined range A at substantially the same altitude as the measurement coordinates. Specifically, the comparative coordinate acquisition section 121 refers to plane coordinates of the measured coordinates and acquires coordinates of a survey point or a GPS-based control station on the same contour line in the map as the comparative coordinates. With this configuration, it is expected that the difference in height-direction coordinate value becomes even smaller, thus enabling a more accurate determination of whether a correct height-direction coordinate value of the measurement coordinates has been measured successfully.

Alternatively, the comparative coordinate acquisition section 121 may acquire, as the comparative coordinates, coordinate information provided from the GPS-based control station D1 or an external system. Examples of the GPS-based control station include GPS-based control stations, which are installed and managed by a public institution such as the Geospatial Information Authority of Japan and provide information about absolute position coordinates, and private reference stations that are installed and managed by a private sector enterprise. Further, the reference station may be a virtual reference station generated based on a technology that produces, from observation data on a plurality of GPS-based control stations, a state as if a reference station is present in close proximity to a survey site.

The coordinate information provided from the external system may be, for example, information on coordinates that is determined from public agricultural land data (Farmland Banks, etc.) managed by an organization that is within the jurisdiction of the Japanese government or Japan's prefectures or information determined from map information provided by a private sector enterprise such as Google® LLC. Here, in a case where the map information mainly provides sets of coordinates of roads, sets of coordinates in an agricultural field may be estimated by reference to sets of coordinates of a road in the vicinity of the agricultural field. Further, the external system may be a survey system relating to automated driving of a ground running machine such as a tractor and may have, for example, a scheme by which survey data are provided from a system owned by another company.

The comparative coordinate acquisition section 121 may extract height-direction coordinate values of a plurality of known coordinate points that are present within the predetermined range A from the measurement coordinates and may acquire the average value of the height-direction coordinate values as a height-direction coordinate value of the comparative coordinates. When the ground surface 1000 within the predetermined range A is assumed to be a flat surface, this configuration enables a more accurate estimation of the altitude of the plane. Therefore, there is a high probability that the average value is close to an actual coordinate value in the height direction at the survey point. That is, the comparison of the average value with a height-direction coordinate value of the measurement coordinates enables a more accurate determination of the appropriateness of the measurement coordinates.

The comparative coordinate acquisition section 121 may calculate differences between the height-direction coordinate values of the plurality of known coordinate points present within the predetermined range A from the measurement coordinates and the height-direction coordinate value of the measurement coordinates. At this time, the comparative coordinate acquisition section 121 may select, from the plurality of known coordinate points present within the predetermined range A, a plurality of points that are present at positions surrounding the measurement coordinates, as sets of comparative coordinates. The determining section 122 may calculate differences between the height-direction coordinate values of the plurality of known coordinate points and the height-direction coordinate value of the measurement coordinates. Since there is a high probability that the predetermined range A is substantially flat, this configuration enables a more accurate determination of the appropriateness of the measurement coordinates.

At this time, the determining section 122 determines differences between height-direction coordinates of the plurality of known coordinate points present at the positions surrounding the measurement coordinates and the height-direction coordinate value of the measurement coordinates. When any one of the differences is greater than a predetermined value, the determining section 122 determines that at least any one of the measurement coordinates and the sets of comparative coordinates used for the calculation of the differences is incorrect. Alternatively, the determining section 122 may determine that the any one of the measurement coordinates or the sets of comparative coordinates is incorrect when a predetermined number of differences more than one among the plurality of calculated differences are greater than the predetermined value.

A threshold value used for the determination of the appropriateness of the difference in the height direction may be constant. The threshold value may differ based on a distance in terms of plane coordinates. For example, the threshold value for the appropriateness may be decreased as the comparative coordinates become closer to the measurement coordinates in terms of the plane coordinates. This is because the probability of the flatness becomes higher as the comparative coordinates become closer to the measurement coordinates in terms of the plane coordinates.

The determining section 122 makes the determination when, for example, the measurement coordinates of the base station 404 are acquired. When determining that there is an error in at least any one of the comparative coordinates and the measurement coordinates of the base station 404, the determining section 122 notifies a user of the determination via the display section 4012 of the operating device 401 to promote the user to perform resurvey.

In a case where there is an error in at least any one of a height-direction measurement coordinate of a survey point P44 and a height-direction coordinate value of comparative coordinates as illustrated in FIG. 9(b), the survey result determination section 12 can detect the error through the same determination as well. In the example in this figure, survey points P41 to P44 are points on the ground surface 1000, and a height-direction coordinate of measured coordinates D44-2 obtained by the coordinate acquisition section 11 is measured as being larger by d2 because of false fixation. Further, there are survey points P50 and P51 and a GPS-based control station D2 in the vicinity of the survey point P44 and within the predetermined range A. The survey result determination section 12 determines the appropriateness of results of measurement for each survey point acquired.

When the survey system 500 receives, via the operating device 401, a command to register an agricultural field based on a plurality of survey points, the determining section 122 determines the appropriateness of each of the plurality of survey points. When determining that at least any one of comparative coordinates and measurement coordinates of at least one of the survey points is incorrect, the determining section 122 inhibits the registration of the agricultural field or issues, via the operating device 401, a notification of promoting resurvey of the survey point. When an obstacle in the agricultural field is to be registered, the determination is made likewise on survey points constituting the obstacle. With this configuration, there is no concern that an agricultural field and obstacles are registered based on an incorrect survey point. Further, it suffices that the determination is made on only the appropriateness of survey points used for the registration of a work area or an obstacle area, which reduces a calculation processing amount compared with a configuration by which the determination is made on all survey points acquired. The registration of an agricultural field will be described later.

When the survey system 500 receives, via the operating device 401, a command to register a flight route on an agricultural field, the determining section 122 may determine the appropriateness of each of a plurality of survey points. When determining that at least any one of comparative coordinates and measurement coordinates of at least one of the survey points is incorrect, the determining section 122 inhibits the registration of the flight route by the route generation device 600. With this configuration, there is no concern that a flight route is registered based on an incorrect survey point, and therefore, when the drone 100 is to fly in the agricultural field, the drone 100 can be prevented from flying, spreading chemical agent, capturing an image, and the like outside the agricultural field, which makes it possible to guarantee safety and work efficiency.

Registration of Agricultural Field

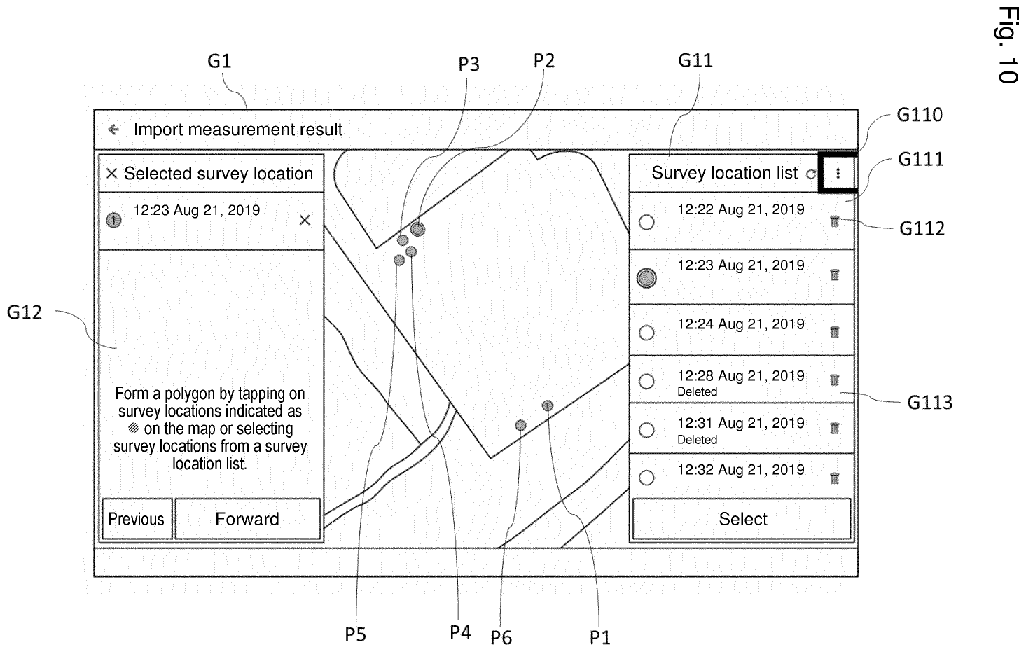

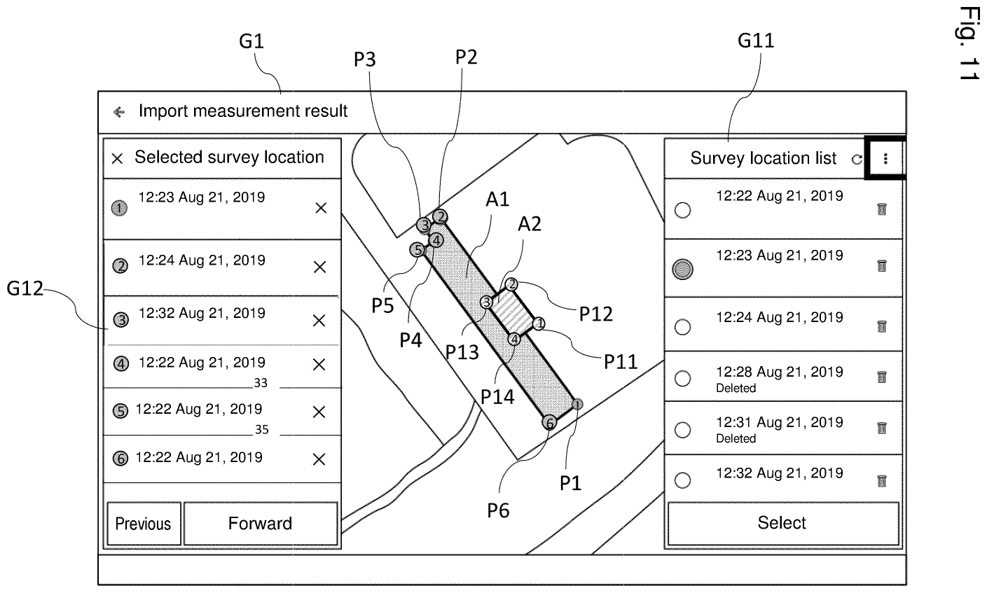

With reference to FIG. 10 and FIG. 11, how the survey point selection section 13 and the area definition section 14 register the agricultural field 403 will be described.

As illustrated in FIG. 10, survey points P1 to P6 acquired by the coordinate acquisition section 11 are displayed on an area definition screen G1 displayed on the display section 4012 in such a manner as to be superimposed on a map or a photograph of the agricultural field. Further, a survey location list window G11 is displayed in the right of the area definition screen G1. The survey location list window G11 displays measurement dates and times of the survey points as a list in order of acquisition with survey device 300. The survey location list window G11 is expanded by tapping an icon G110 at the upper-right of the survey location list window G11 and is collapsed by tapping the icon G110 again. Further, a trash-can icon G112 is displayed for each column G111 of a survey point, and data on the survey point can be deleted by tapping the icon G112. A column G113 of a deleted survey point is displayed with a note “deleted”.

The survey point selection section 13 is a functional section that accepts the selection of survey points by a user on the display section 4012 of the operating device 401. The user selects survey points in at least any one of manners that include tapping the survey points on the map or the photograph of the agricultural field displayed on the area definition screen G1 and tapping the survey points in the list displayed in the survey location list window G11. With a configuration that allows survey points to be selected on the survey location list window G11, even when a plurality of survey points are so close to one another that tapping a survey point on the map in distinction from the others is difficult, the survey points can be selected one by one.

As illustrated in FIG. 11, information on the selected survey point is displayed in a selected location list window G12 that is disposed in the left of the area definition screen G1. In the selected location list window G12, orders of selection on the display section 4012 may be displayed in combination. In the selected location list window G12, selected survey points are displayed in order of the selection from the top to the bottom of this diagram. In the selected location list window G12, unselection by a predetermined input, for example, tapping the portion “×”, may be accepted.

The survey point selection section 13 may be configured to accept only the selection of survey points accompanied with the same area type. That is, the survey point selection section 13 permits survey points accompanied with the same area type information to be connected and inhibits survey points accompanied with different pieces of area type information from being connected. A warning may be displayed for the selection of survey points accompanied with different pieces of area type information. For example, in a case where a survey point selected for the first time is linked to information indicating that the survey point is located in the agricultural field, only survey points each indicating coordinates of an outer edge of the agricultural field may be made selectable from the second time onwards. That is, survey points each indicating coordinates of an outer edge of an obstacle may be made unselectable. Further, an input of an area type to be defined may be received before an operation of selecting survey points, and selectable survey points may be displayed based on the inputted area type. In the definition of an agricultural field or an obstacle area, the selection of survey points of the same area type with reliability enables the area definition of the agricultural field and the obstacle area to be made accurately.

The survey point selection section 13 may have a function of changing an accompanying area type for each survey point. The survey point selection section 13 may be configured, in a case where the survey point is used for defining an area of which a type is different from a type of the survey point, to accept selection for each area type after changing the area type of the survey point. With this configuration, even in a case where an incorrect area type is inputted at the time of measurement with the survey device 300, the area definition can be performed without resurvey.

The survey point selection section 13 may allow the selection of survey points irrespective of their area types that are linked at the time of the measurement with the survey device 300. In this case, a user is allowed to select an area type with an area type selection section 142 described later.

In the survey location list window G11, survey points each indicating coordinates of an outer edge of the agricultural field may be displayed in a mode different from that of survey points each indicating coordinates of an outer edge of an obstacle, or only the survey points each indicating the coordinates of the outer edge of the agricultural field may be displayed. The survey points each indicating coordinates of the outer edge of the obstacle may be displayed as grayed out. Displaying survey points differently based on the area types of the survey points enables a user to reduce mistakes in selection.

The area definition section 14 is a functional section that demarcates an area by connecting a plurality of survey points received by the survey point selection section 13, thus defining the area of an agricultural field or an obstacle. The area definition section 14 includes an outer edge definition section 141 and the area type selection section 142.

The outer edge definition section 141 illustrated in FIG. 8 connects the plurality of survey points received by the survey point selection section 13, and demarcates the area, thus defining the area. The outer edge definition section 141 may connect the survey points in order of accepting the selection by the survey point selection section 13, and may use these connecting lines as lines indicating outer edges of the area. This configuration allows a user to define the area intuitively by tapping the survey points on the area definition screen G1 in such a manner as to enclose the area to be defined. In a case where one area is not defined by the connecting procedure described above, an error notification may be issued via a user interface device such as the operating device 401. That is, the area definition section 14 determines whether the survey points have been selected in such an order that the connecting lines intersect one after another and issues a notification of an error when the survey points are selected in such an order that at least some of the connecting lines intersect one after another. Examples of the case where one area is not defined include a case where connecting lines intersect with each other.

The outer edge definition section 141 may connect the plurality of survey points of which the selection is accepted by the survey point selection section 13, to define an area in such a manner that the survey points each serve as an endpoint of an outer edge or a point on an edge of one area. For example, the outer edge definition section 141 may connect survey points that are adjacent to each other in terms of coordinates. With this configuration, an area to be defined can be generated automatically. In a case where there are a plurality of possible areas to be generated based on the selected survey points, the outer edge definition section 141 may employ an area that is generated to have the largest area.

The area type selection section 142 is a functional section that selects an area type of the area defined by the outer edge definition section 141. The area type selection section 142 may determine the type of the area based on information on a type that is linked at the time of measurement with the survey device 300. Further, the area type selection section 142 may accept the selection as to whether the area defined by the outer edge definition section 141 is an agricultural field or an obstacle. Further, the area type selection section 142 may be configured, when the area defined by the outer edge definition section 141 is an obstacle area, to further accept a detailed type of and associated information on the obstacle. For example, the area type selection section 142 may be configured to be capable of registering, as the detailed type of the obstacle, “guardrail”, “utility pole”, “electric wire”, “tree”, and the like and capable of registering, as the associated information, information on a vertical-direction coordinate (position) of the obstacle.

As illustrated in FIG. 11, the area output section 15 displays an area A1 to be defined in a superimposing manner on the agricultural field displayed on the area definition screen G1. In addition to or in place of this, the area output section 15 outputs information on the area to the route generation device 600 that generates a flight route of the drone 100. In a case where there are a plurality of possible areas to be generated by the area definition section 14, the area output section 15 may make a display to that effect on the display section 4012. Further, the plurality of areas may be displayed in a selectable or superimposing manner, thus promoting a user to select an area to employ.

Further, the area output section 15 displays an area A2 that is defined by the selection of the survey points P11, P12, P13, and P14 in a superimposing manner on the agricultural field on the area definition screen G1. The area A2 is of an area type different from that of the area A1. For example, the area A1 is a work area, and the area A2 is an obstacle area. The obstacle area is displayed in a mode different from that of the work area. For example, the obstacle area and the work area may differ from each other in the color or pattern of shading of the area.

The user may define an area by selecting survey points in at least any one of manners that include tapping the survey points on the map or the photograph of the agricultural field displayed on the area definition screen G1 and tapping the survey points in the list displayed in the survey location list window G11, thereby connecting the survey points in order of the selection. Further, the area definition section 14 may have a function of defining an area by automatically connecting a plurality of survey points in such a manner that the survey points each serve as an endpoint of an outer edge or a point on an edge of one area.

Flow of Processing for Determining Appropriateness of Base Station Coordinates

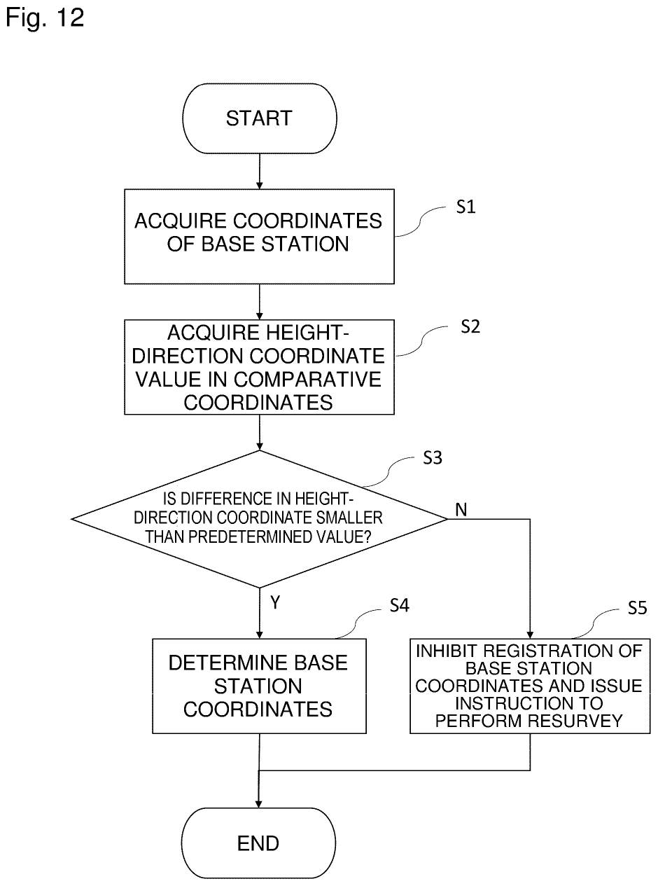

As illustrated in FIG. 12, first, coordinates of the base station 404 are acquired from a satellite signal (S1). Next, coordinates to be compared are determined based on plane coordinates of the acquired base station coordinates, and at least a height-direction coordinate value is acquired (S2). A difference between a height-direction coordinate value of the base station coordinates and the height-direction coordinate value of the comparative coordinates is calculated, and whether the difference is smaller than a predetermined value is determined (S3). When the difference is smaller than the predetermined value, the base station coordinates acquired in step S1 are determined and registered as coordinates of the base station 404 (S4). When the difference is not less than the predetermined value in step S3, the registration of the base station coordinates acquired in step S1 is inhibited, and a notification indicating the need of resurvey is issued via the display section 4012 of the operating device 401 or the like (S5). Note that the inhibition and the issuance in step S5 are in no particular order and may be performed simultaneously. At this time, the base station 404 may perform resurvey.

Flow of Processing for Determining Appropriateness of Survey Point Coordinates (1)

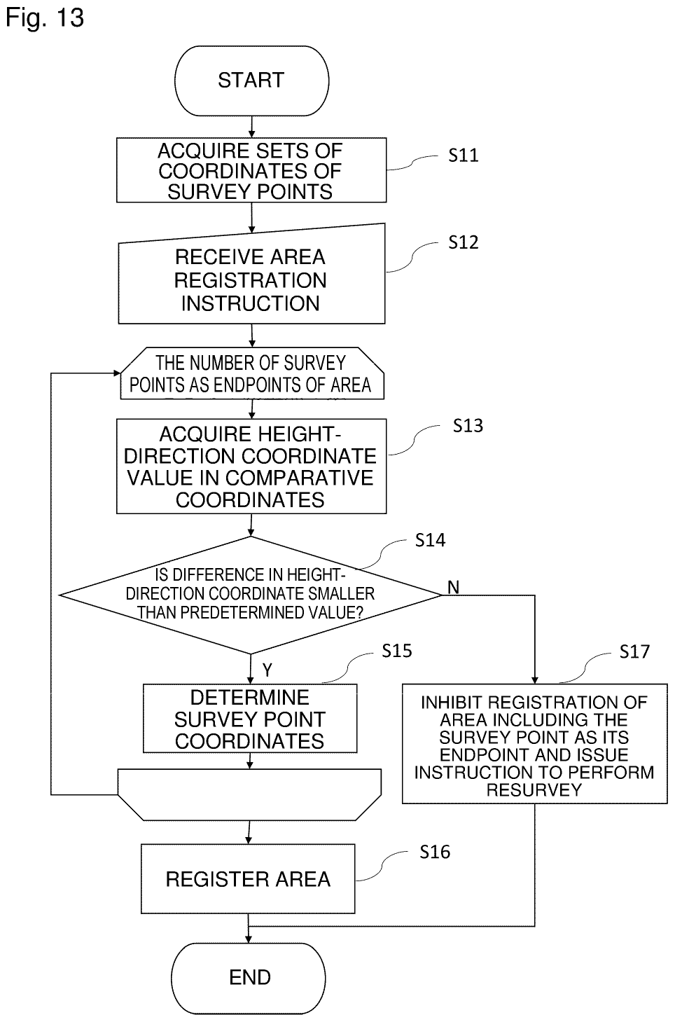

As illustrated in FIG. 13, first, coordinates of a survey point measured with the survey device 300 are acquired from a satellite signal (S11). Next, when an instruction to register a target area is received via the operating device 401 or the like, (S12), a process of determining the appropriateness of acquired coordinates shown as steps S13 to S15 is performed on each of survey points that define endpoints of the target area.

In step S13, coordinates to be compared are determined based on plane coordinates of the survey point coordinates acquired in step S11, and at least a height-direction coordinate value is acquired. Next, a difference between a height-direction coordinate value of the survey point coordinates and the height-direction coordinate value of the comparative coordinates is calculated, and whether the difference is smaller than a predetermined value is determined (S14). When the difference is smaller than the predetermined value, the survey point coordinates acquired in step S11 are determined as coordinates of the survey point (S15). Steps S13 to S15 are repeated, and when the coordinates of all the survey points defining the endpoints of the target area are determined, the target area is registered (S16).

When the difference is not less than the predetermined value in step S14, the repetitive processing of steps S13 to S15 is interrupted, and the registration of the target area including the survey points as its endpoints is inhibited. Further, a notification indicating the need of resurvey is issued via the display section 4012 of the operating device 401 or the like (S17). Note that the inhibition and the issuance in step S17 are in no particular order and may be performed simultaneously. At this time, a survey point for which the resurvey is needed may be displayed in distinction from the others on the map or the list window displayed on the display section 4012.

Flow of Processing for Determining Appropriateness of Survey Point Coordinates (2)

A second embodiment of the flow of processing for determining the appropriateness of survey point coordinates will be described focusing on differences from a first embodiment illustrated in FIG. 13. The same steps are given the same reference characters as those in FIG. 13.

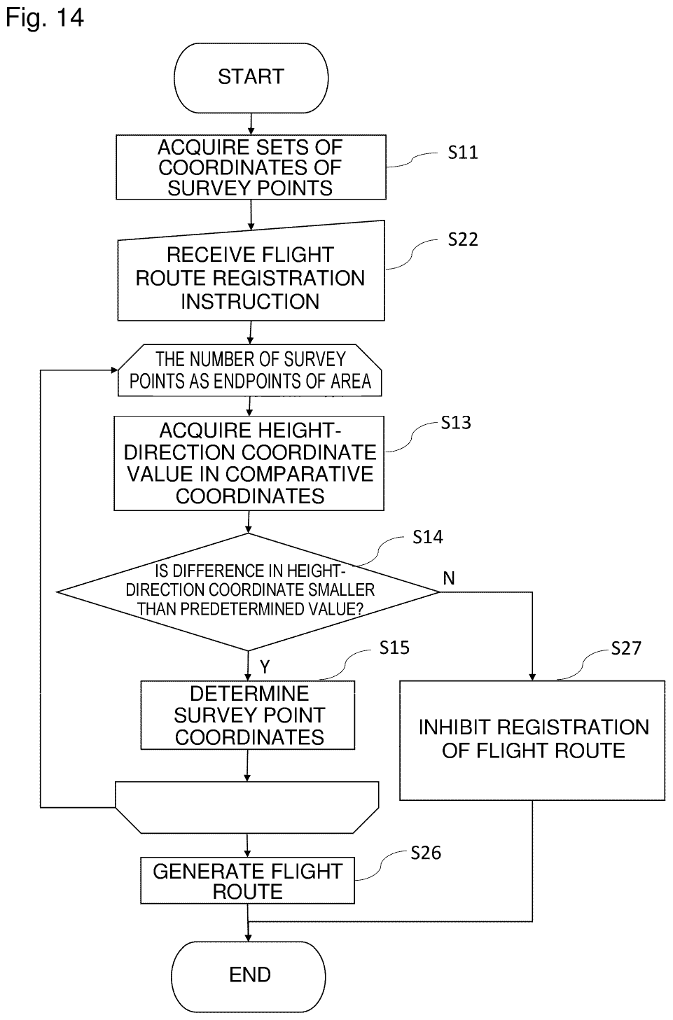

As illustrated in FIG. 14, first, coordinates of a survey point measured with the survey device 300 are acquired from a satellite signal (step S11), and when an instruction to register a flight route is received via the operating device 401 or the like, (S22), a process of determining the appropriateness of acquired coordinates shown as steps S13 to S15 is performed on each of survey points that define endpoints of a work area in which the flight route is to be generated. Steps S13 to S15 are repeated, and when the coordinates of all the survey points defining the endpoints of the target area are determined, the flight route is registered (S26).

When the difference in height-direction coordinate is not less than the predetermined value in step S14, the repetitive processing of steps S13 to S15 is interrupted, and the registration of the flight route in the target area including the survey points as its endpoints is inhibited (S27). Further, a notification indicating the need of resurvey may be issued via the display section 4012 of the operating device 401 or the like.

Note that the drone is not limited to a drone of a form that flies autonomously in a work area. For example, the drone may be a drone that flies under control by a user in part or all of the work area or on a moving route between a takeoff-landing point and the work area. Further, the survey system is not limited to that for surveying a work area of a drone. For example, the survey system may be used for surveying a work area of a machine that runs autonomously on the ground.

(Technically Advantageous Effects of the Invention of the Present Application)

According to the invention of the present application, it is possible to perform the survey of an agricultural field accurately.

1. A survey system for surveying an area, the survey system comprising:
a coordinate acquisition section that acquires a set of three-dimensional coordinates of a survey point or a base station used for determining sets of coordinates of the area, as a set of measurement coordinates;
a comparative coordinate acquisition section that acquires at least a height-direction coordinate value of a set of comparative coordinates indicating a position within a predetermined range from the acquired set of measurement coordinates; and
a determining section that calculates a difference between a height-direction coordinate value of the set of measurement coordinates and the height-direction coordinate value of the set of comparative coordinates and determines that at least any one of the set of measurement coordinates and the set of comparative coordinates are incorrect when the difference is larger than a predetermined value.

2. The survey system according to claim 1, wherein
the comparative coordinate acquisition section extracts plane coordinates of the set of measurement coordinates, specifies the set of comparative coordinates of which the plane coordinates are within the predetermined range, and acquires at least the height-direction coordinate value of the set of comparative coordinates.

3. The survey system according to claim 1, wherein
the comparative coordinate acquisition section takes, as the set of comparative coordinates, a set of coordinates of a second survey point that differs from the survey point in an acquisition time of a set of coordinates of the base station that is referred to for positioning the survey point.

4. The survey system according to claim 1, wherein
the comparative coordinate acquisition section takes, as the set of comparative coordinates, coordinate information provided from a GPS-based control station or an external system.

5. The survey system according to claim 1, wherein
the comparative coordinate acquisition section takes, as the height-direction coordinate value of the set of comparative coordinates, an average value in a height direction of coordinate values of a plurality of neighborhood survey points or GPS-based control stations that are present within the predetermined range from the measurement coordinates.

6. The survey system according to claim 1, wherein
the comparative coordinate acquisition section acquires a plurality of sets of comparative coordinates that are present within the predetermined range from the set of measurement coordinates and present at positions surrounding the set of measurement coordinates, and
the determining section calculates differences between height-direction coordinates of the plurality of sets of comparative coordinates and the height-direction coordinate value of the set of measurement coordinates, performs the determination based on the differences, and determines that at least any one of the set of measurement coordinates and the sets of comparative coordinates is incorrect when any one of the differences is greater than a predetermined value.

7. The survey system according to claim 1, wherein
when the survey system receives a command to register the area based on a plurality of the survey points that have been measured and used for determining sets of coordinates of the area, the determining section performs the determination on each of the plurality of survey points, and
when determining, for a set of measurement coordinates of at least one of the survey points, that any one of a set of the comparative coordinates and the set of measurement coordinates is incorrect, the determining section inhibits registration of the area or issues, via an interface device, a notification of promoting resurvey of the survey point.

8. The survey system according to claim 1, wherein
when the survey system receives a command to register a flight route for the area based on a plurality of the survey points, the determining section performs the determination on each of the plurality of survey points, and
when determining, for a set of measurement coordinates of at least one of the survey points, that any one of a set of the comparative coordinates and the set of measurement coordinates is incorrect, the determining section inhibits registration of the flight route.

9. The survey system according to claim 1, wherein
when determining that at least any one of the set of measurement coordinates of the base station and the set of comparative coordinates is incorrect, the determining section inhibits measurement of the survey point.

10. A survey method for surveying an area, the survey method comprising:
a coordinate acquisition step of acquiring a set of three-dimensional coordinates of a survey point or a base station used for determining sets of coordinates of the area, as a set of measurement coordinates;
a comparative coordinate acquisition step of acquiring at least a height-direction coordinate value of a set of comparative coordinates indicating a position within a predetermined range from the acquired set of measurement coordinates; and
a determining step of calculating a difference between a height-direction coordinate value of the set of measurement coordinates and the height-direction coordinate value of the set of comparative coordinates and determining that at least any one of the set of measurement coordinates and the set of comparative coordinates are incorrect when the difference is larger than a predetermined value.

11. A survey program for surveying an area, the survey program causing a computer to execute:
a coordinate acquisition command to acquire a set of three-dimensional coordinates of a survey point or a base station used for determining sets of coordinates of the area, as a set of measurement coordinates;
a comparative coordinate acquisition command to acquire at least a height-direction coordinate value of a set of comparative coordinates indicating a position within a predetermined range from the acquired set of measurement coordinates; and
a determining command to calculate a difference between a height-direction coordinate value of the set of measurement coordinates and the height-direction coordinate value of the set of comparative coordinates and determine that at least any one of the set of measurement coordinates and the set of comparative coordinates are incorrect when the difference is larger than a predetermined value.
